(19) United States
(12) Patent Application Publication
(10) Pub. No.: US 2008/0268304 A1
(43) Pub. Date: Oct. 30, 2008

(54) PLATE-TYPE REACTOR FOR FUEL CELL AND FUEL CELL SYSTEM THEREWITH

(76) Inventors: Yong-Kul Lee, Yongin-si (KR); Ju-Yong Kim, Yongin-si (KR); Sung-Chul Lee, Yongin-si (KR); Man-Seok Han, Yongin-si (KR); Jin-Goo Ahn, Yongin-si (KR)

Correspondence Address: CHRISTIE, PARKER & HALE, LLP, PO BOX 7068, PASADENA, CA, 91109-7068, US

(21) Appl. No.: 12/035,387

(22) Filed: Feb. 21, 2008

(30) Foreign Application Priority Data
Apr. 25, 2007 (KR) 10-2007-0040249

(51) Int. Cl. H01M 8/06; B05D 5/12

(52) U.S. Cl. 429/19; 427/115

(57) ABSTRACT

A plate-type reactor for a fuel cell is provided. The plate-type reactor includes a plate-type reactor main body having a path for allowing a reactant to flow and a catalyst formed in the path to promote a chemical reaction of the reactant. The catalyst is composed of a first catalyst layer coated on a surface of the path and a second catalyst layer filled in a remaining space of the path.

### CROSS-REFERENCE TO RELATED APPLICATION

This application claims priority to and the benefit of Korean Patent Application No. 10-2007-0040249 filed in the Korean Intellectual Property Office on Apr. 25, 2007, the entire content of which is incorporated herein by reference.

### BACKGROUND OF THE INVENTION

1. Field of the Invention

The present invention relates to a plate-type reactor for a fuel cell and a fuel cell system including the same, and more particularly, to a reformer in which a channel and a catalyst layer are formed on a substrate.

2. Description of the Related Art

As is well known, a fuel cell is an electricity generating system for generating electrical energy using a fuel and an oxidant gas. The fuel cell may be either a polymer electrolyte membrane fuel cell or a direct oxidation membrane fuel cell.

The polymer electrolyte membrane fuel cell generates electrical energy in an electrochemical reaction between a reforming gas generated in a reformer and an oxidant gas which is different from the reforming gas.

The reformer has a structure in which the reforming gas with abundant hydrogen is generated in a chemical reaction of a fuel by the use of a catalyst. Recently, in order to meet a demand for a small-sized, light-weight reformer, a plate-type reactor in which a channel is formed on a substrate, a cover is disposed on the substrate so as to form a path by a covering surface of the cover and the channel, and a catalyst layer is formed on an inner wall of the path has been proposed.

However, such a conventional plate-type reformer has a problem in that a contact area ratio of a catalyst material to a reactant, a conversion rate of the reactant per unit catalytic amount, and a catalyst usage rate deteriorate. This is because a mass transfer rate of the reactant with respect to the catalyst layer has a limit considering that the flow of the reactant is a laminar flow since the catalyst layer is coated on the surface of the path.

### SUMMARY OF THE INVENTION

In accordance with the present invention a plate-type reactor for a fuel cell is provided having advantages of increasing the contact area between a catalyst layer and a reactant by improving the structure of the catalyst layer formed in a channel, and of improving the mass transfer rate of the reactant with respect to the catalyst material.

An exemplary embodiment of the present invention provides a plate-type reactor for a fuel cell.

According to an embodiment of the present invention, the plate-type reactor includes a plate-type reactor main body having a path for allowing a reactant to flow and a catalyst formed in the path to promote a chemical reaction of the reactant, wherein the catalyst is composed of a first catalyst layer coated on a surface of the path and a second catalyst layer filled in a remaining space of the path.

The reactor main body includes a reaction substrate having a channel on a surface thereof, and a cover plate bonded to the surface of the reaction substrate to form the path.

The reactor main body is constructed such that the reaction substrate is provided in a plural number and the reaction substrates are consecutively laminated to form the reaction substrates having an integral structure.

The first catalyst layer is coated on a surface of the channel.

The reactor main body includes a bonding portion that is melted to be formed on an adhering portion between the reaction substrate and the cover plate so as to integrally bond the reaction substrate to the cover plate.

The adhering portion of the reaction substrate excludes a portion where the channel is formed.

A thickness of the first catalyst layer has a range of 1/10˜⅖ in the overall thickness of the first catalyst layer and the second catalyst layer.

The second catalyst layer is composed of pellet-shaped unit catalysts.

A porosity of each unit catalyst with respect to the second catalyst layer is in a range of 40%-60%.

The plate-type reactor further includes screen members respectively disposed at an entrance and an exit of the path. Each screen member has a mesh size in a range of 20%-60% of each unit catalyst.

The reactor main body includes bonding grooves so as to place the screen members respectively at the entrance and the exit of the path.

The reactor main body includes a reactant inlet connected to the entrance of the path and a product outlet connected to the exit of the path.

The reactant includes a fuel containing hydrogen as a main component, and the plate-type reactor includes a reformer that generates a reforming gas in a reforming reaction of the fuel.

### BRIEF DESCRIPTION OF THE DRAWINGS

FIG. 1 is a schematic diagram showing the structure of a fuel cell system according to a first embodiment of the present invention.

FIG. 2 is a perspective view of a plate-type reactor for a fuel cell according to a first embodiment of the present invention.

FIG. 3 is a cross-sectional view taken along line II-II of FIG. 2.

FIG. 4 is a perspective view of a reaction substrate shown in FIG. 3.

FIG. 5 is a cross-sectional view of a plate-type reactor for a fuel cell according to a second embodiment of the present invention.

FIG. 6 is an exploded perspective view of a plate-type reactor for a fuel cell according to a third embodiment of the present invention.

FIG. 7 is a cross-sectional view of a bonding portion taken along line III-III of FIG. 6.

### DETAILED DESCRIPTION OF THE EMBODIMENTS

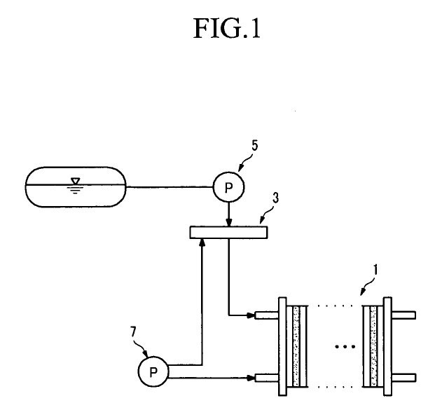

As shown in FIG. 1, the fuel cell system includes a stack including an electricity generating element 1 that generates electrical energy through electrochemical reactions, a plate-type reactor 3 that generates hydrogen gas from a liquid fuel and supplies the hydrogen gas, a fuel supplier 5 for supplying a fuel to the plate-type reactor 3, and an oxidant supplier 7 for supplying an oxidant to the plate-type reactor 3 and to the electricity generating element 1, respectively.

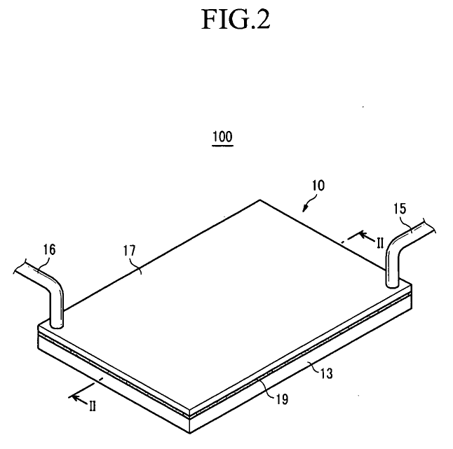

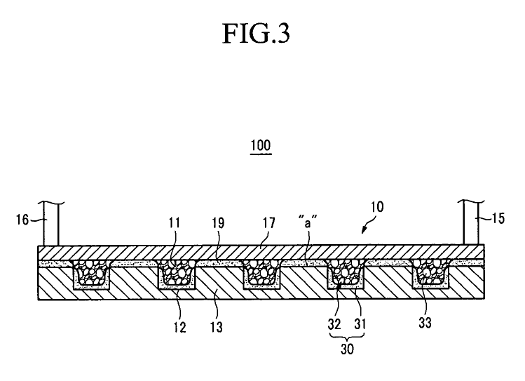

Referring to FIGS. 2 and 3, a plate-type reactor 100 of the present embodiment is composed of a reformer used in a conventional fuel cell system of FIG.1. The plate-type reactor 100 has a structure in which a specific product (e.g., a reforming gas with abundant hydrogen) is generated in a chemical reaction of a reactant containing a fuel, and the reforming gas is supplied to the fuel cell.

In this case, the fuel cell may be composed of a conventional polymer electrolyte membrane fuel cell (PEMFC) that generates electrical energy in an electrochemical reaction between the reforming gas and an oxidant gas that is different from the reforming gas.

The fuel may be compressed and stored in a state of an alcohol liquid fuel, such as methanol and ethanol, or in a state of partial liquefaction in a specific container. Also, the fuel may include a liquefied gas fuel that exists in a gaseous state at room temperature.

The plate-type reactor 100 includes a plate-type reactor main body 10 having a path 11 for allowing a reactant to flow, and a catalyst 30 formed in the path 11.

The reactor main body 10 is made of a metal material and has a rectangular plate shape. Specifically, the reactor main body 10 includes a reaction substrate 13 having a channel 12 formed on a surface thereof, a cover plate 17 closely bonded to the surface of the reaction substrate 13, and a bonding portion 19 for bonding the cover plate 17 to the reaction substrate 13.

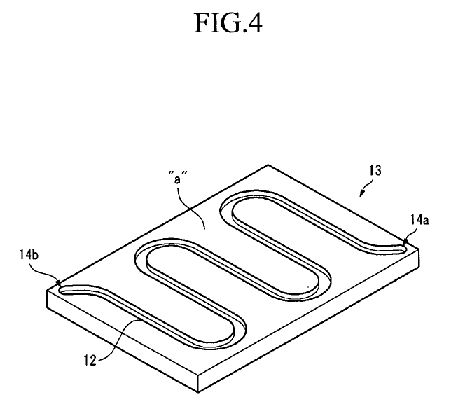

Referring to FIG. 4, the channel 12 is formed on a certain portion of the upper surface of the reaction substrate 13 so as to provide a flow path for the reactant. The channel 12 has a serpentine shape. The remaining portion of the upper surface thereof, which excludes the portion where the channel 12 is formed, is defined as an adhering portion “a” to which the cover plate 17 is adhered.

In addition, the reaction substrate 13 includes manifolds 14a, 14b respectively connected to ends of the channel 12. The reactant and the product flow through the manifolds 14a, 14b.

The cover plate 17 has a shape corresponding to the reaction substrate 13. Further, the cover plate 17 is bonded to the adhering portion “a” of the reaction substrate 13 through the bonding portion 19 that will be described below in more detail.

In the reactor main body 10 of the present embodiment, the cover plate 17 is adhered to the adhering portion “a” of the reaction substrate 13, and thus the path 11 can be formed by a covering surface of the cover plate 17 and the channel 12. As a result, the reactant can flow through the path 11.

The bonding portion 19 is melted to be formed between the adhering portion “a” of the reaction substrate 13 and the covering surface of the cover plate 17. The bonding portion 19 serves to integrally bond the reaction substrate 13 to the cover plate 17.

The bonding portion 19 may be formed when a thin metal plate (corresponding to the adhering portion of the reaction substrate) disposed between the reaction substrate 13 and the cover plate 17 is melted by heat.

A bonding method in which a specific thin metal plate or film is disposed between two or more base materials and is then melted by heat so as to bond the base materials is generally called a brazing bonding method in the art.

In the present embodiment, the catalyst 30 promotes a chemical reaction (e.g., a fuel reforming reaction) of the reactant. The catalyst 30 is formed in the path 11 of the reactor main body 10.

Here, the main component of the catalyst 30 is a catalyst material of a noble metal or transition metal such as copper (Cu), nickel (Ni), or platinum (Pt).

The catalyst 30 is composed of a first catalyst layer 31 coated on a surface of the path 11 and a second catalyst layer 32 filled in a remaining space of the path 11.

Since the first catalyst layer 31 is coated on the surface of the channel 12 of the reaction substrate 13 using a slurry or wash-coating method. The first catalyst layer 31 is supported by a typical carrier layer (not shown) formed on the surface of the channel 12.

The thickness of the first catalyst layer 31 has a range of 1/10˜⅖ in the overall thickness of the first catalyst layer 31 and a second catalyst layer 32 that will be described below. That is, when the thickness of the first catalyst layer 31 is less or more range of 1/10˜⅖, a porosity of the second catalyst layer 32 can be decreased and a reactant pressure of the second catalyst layer 32 can be reduced.

The second catalyst layer 32 is filled in the remaining space of the path 11 of the reactor main body 10, which excludes the portion where the catalyst layer 31 is formed. The second catalyst layer 32 is composed of a plurality of unit catalysts 33 having a pellet shape. Each unit catalyst 33 is constructed such that the aforementioned catalyst material is carried on a surface of a spherical supporting body.

The porosity of each unit catalyst 33 with respect to the second catalyst layer 32 may be in a range of 40%-60%. That is, when the porosity of each unit catalyst 33 is less than 40%, a pump electric power consumption can be increased since the reactant pressure of the second catalyst layer 32 is reduced. On the other hand, when the porosity of each unit catalyst 33 is more than 60%, the size of the plate-type reactor 100 can be larger since the surface area of each unit catalyst 33 per unit volume is decreased.

The main reason that the catalyst 30 formed in the path 11 of the reactor main body 10 is composed of the first catalyst layer 31 and the second catalyst layer 32 is to increase the contact area between the reactant and the catalyst 30. In this case, the larger the contact area between the catalyst 30 and the reactant, the higher the mass transfer rate of the reactant with respect to the catalyst 30.

Referring to FIGS. 2 and 3, the reactor main body 10 of the present embodiment includes a reactant inlet 15 connected to an entrance of the path 11, and a product outlet 16 connected to an exit of the path 11.

The reactant inlet 15 is a pipe connected to the first manifold 14a of the reaction substrate 13 shown in FIG. 4. The reactant inlet 15 serves to inject the reactant into the path 11 (FIG. 3).

The product outlet 16 is a pipe connected to the second manifold 14b of the reaction substrate 13 shown in FIG. 4. The product outlet 16 serves to discharge the product that is produced while the reactant is processed with the catalyst 30 (FIG. 3).

According to the operation of the plate-type reactor 100 of the present embodiment, the reactant injected into the path 11 of the reactor main body 10 passes the first catalyst layer 31 coated on the surface of the path 11 and the second catalyst layer 32 filled in the remaining space of the path 11.

Through this process, the reactant is converted to a product such as a reforming gas in a chemical reaction (preferably, a fuel reforming reaction) prompted by the first and second catalyst layers 31 and 32.

Since the first catalyst layer 31 is coated on the surface of the path 11 and the second catalyst layer 32 is filled in the remaining space of the path 11, the contact area between the reactant and the catalyst 30 increases.

Accordingly, with the increase of the contact area between the reactant and the catalyst 30, the mass transfer rate of the reactant with respect to the catalyst 30, the conversion rate of the reactant per unit catalytic amount, and the catalyst usage rate are further improved. Therefore, in the present embodiment, the total volume of the reactor can be reduced while the conversion rate of the reactant is maintained at 90% or more.

As a comparative example, when only the first catalyst layer 31 is formed in the path 11, considering that the flow of the reactant is a laminar flow, it is natural that the contact area between the catalyst material and the reactant and the mass transfer rate of the reactant with respect to the catalyst material are lower than those in the present embodiment. This means that the conversion rate of the reactant per unit catalytic amount and the catalyst usage rate in the comparative example are lower than those in the present embodiment.

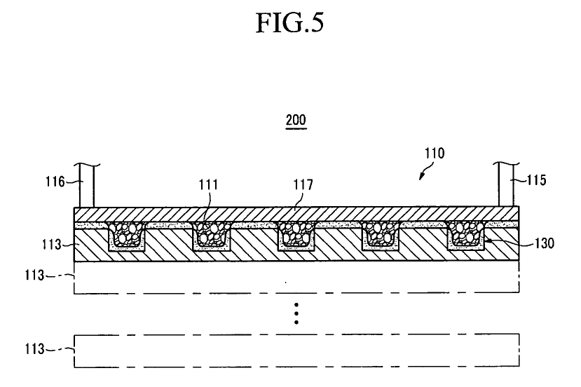

FIG. 5 is a cross-sectional view of a plate-type reactor for a fuel cell according to a second embodiment of the present invention.

Referring to FIG. 5, a plate-type reactor 200 of the present embodiment basically has the same structure as the first embodiment except that a plurality of reaction substrates 113 may be consecutively laminated to form a reactor main body 110.

The reactor main body 110 is constructed such that a cover plate 117 is bonded to the uppermost reaction substrate 113, and the rest of the reaction substrates 113 indicated by a dash-dot line in the figure are consecutively bonded.

In the reactor main body 110, similar to the first embodiment, a path 111 and a catalyst 130 are formed between the cover plate 117 and the reaction substrate 113 as well as between the reaction substrate 113 and the reaction substrate 113.

Here, the reactor main body 110 can supply a reactant to the path 111 through a reactant inlet and can discharge a product produced inside the path 111 through a product outlet 116.

The rest of structural and operational descriptions of the plate-type reactor 200 are the same as those in the first embodiment. Thus, detailed descriptions thereof will be omitted.

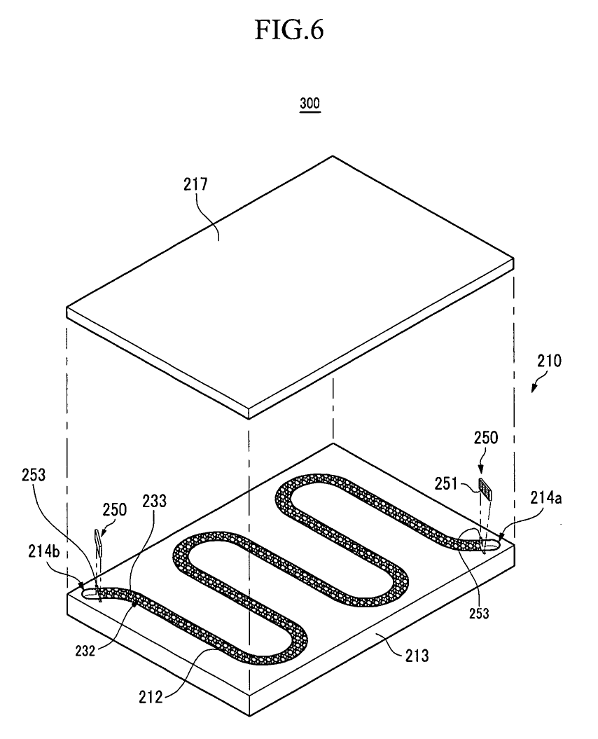

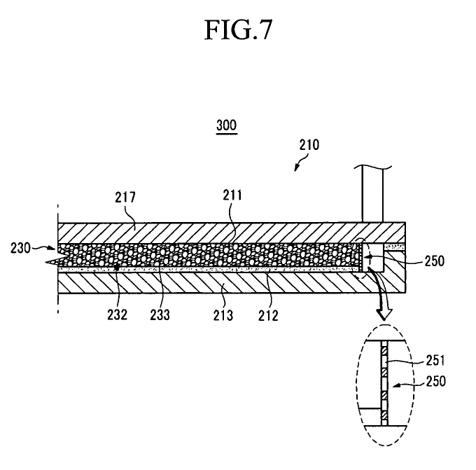

FIG. 6 is an exploded perspective view of a plate-type reactor for a fuel cell according to a third embodiment of the present invention. FIG. 7 is a cross-sectional view of FIG. 6 taken along section III-III, showing a screen member.

Referring to FIGS. 6 and 7, a plate-type reactor 300 of the present embodiment basically has the same structure as those in the pervious embodiments except that a reactor main body 210 is constructed such that screen members 250 are disposed at an entrance and an exit of a path 211.

In the present embodiment, the screen members 250 are fixedly disposed at positions where ends of a channel 212 are connected with respective manifolds 214a, 214b on a reaction substrate 213. The screen members 250 serve to prevent a catalyst 230 inside the path 211 from being discharged to the manifolds 214a, 214b. The screen members 250 are inserted into and are thus supported by bonding grooves 253 formed where ends of the channel 212 are connected to the respective manifolds 214a, 214b. Further, the screen members 250 are fixed by a cover plate 217 bonded to the reaction substrate 213.

Each screen member 250 has a mesh size in a range of 20%-60% of each unit catalyst 233. Thus, a plurality of holes 251 are formed on each screen member 250 to have a size of which unit catalysts 233 of a second catalyst layer 232 cannot pass through.

Therefore, by disposing the screen members 250 at the entrance and the exit of the path 211, the catalyst 230 inside the path 211 can be prevented from being discharged to the manifolds 214a, 214b of the reaction substrate 213.

Therefore, in the present embodiment, a problem can be solved in which a reactant pressure sharply increases at the manifolds 214a, 214b when the catalyst 230 inside the path 211 is discharged to the manifolds 214a, 214b of the reaction substrate 213.

In addition, when the reactor main body 210 of the present embodiment has a laminated structure as in the second embodiment, the catalyst 230 inside the path 211 is not discharged to the manifolds 214a, 214b of the reaction substrate 213 due to the screen members 250. Thus, the reactant can be uniformly supplied to the respective layers. That is, by reducing a reactant pressure gradient acting on each layer, a flow-rate deviation of the reactant supplied to each layer can be reduced.

The rest of structural and operational descriptions of the plate-type reactor 300 of the present embodiment are the same as those in the previous embodiments. Thus, detailed descriptions thereof will be omitted.

According to the aforementioned embodiments of the present invention, since a first catalyst layer is coated on a surface of a path in a reactor main body and a second catalyst layer is filled in a remaining space of the path, a contact area between a catalyst and a reactant can increase. Therefore, the mass transfer rate of the reactant with respect to the catalyst, the conversion rate of the reactant per unit catalytic amount, and the catalyst usage rate can be further improved, thereby decreasing the total volume of a reactor.

In addition, since screen members are respectively disposed at an entrance and an exit of the path, the catalyst can be prevented from being discharged out of the path. Further, when the reactor has a laminated structure, the reactant can be uniformly supplied to each layer at a constant flow-rate. Accordingly, there is an advantage in that the reactor can have improved operation performance, durability, and reliability.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plate-type reactor for a fuel cell, comprising:
a plate-type reactor main body having a path for allowing a reactant to flow; and
a catalyst in the path to promote a chemical reaction of the reactant,
wherein the catalyst comprises a first catalyst layer coated on a surface of the path and a second catalyst layer filled in a remaining space of the path.

2. The plate-type reactor for a fuel cell of claim 1, wherein the plate-type reactor main body comprises:
a reaction substrate having a channel on a surface of the reaction substrate, and
a cover plate bonded to the surface of the reaction substrate to form the path.

3. The plate-type reactor for a fuel cell of claim 2, wherein the plate-type reactor main body comprises a plurality of reaction substrates consecutively laminated to form an integrated reaction substrate structure.

4. The plate-type reactor for a fuel cell of claim 2, wherein the first catalyst layer is coated on a surface of the channel.

5. The plate-type reactor for a fuel cell of claim 2, wherein the plate-type reactor main body includes a bonding portion melted onto an adhering portion of the reaction substrate between the reaction substrate and the cover plate to integrally bond the reaction substrate to the cover plate.

6. The plate-type reactor for a fuel cell of claim 5, wherein the adhering portion of the reaction substrate excludes the channel.

7. The plate-type reactor for a fuel cell of claim 1, wherein a thickness of the first catalyst layer has a range of 1/10 to ⅖ of the overall thickness of the first catalyst layer combined with the second catalyst layer.

8. The plate-type reactor for a fuel cell of claim 1, wherein the second catalyst layer comprises pellet-shaped unit catalysts.

9. The plate-type reactor for a fuel cell of claim 8, wherein a porosity of each unit catalyst is in a range of 40% to 60% of the second catalyst layer.

10. The plate-type reactor for a fuel cell of claim 8, further comprising screen members respectively disposed at an entrance and an exit of the path.

11. The plate-type reactor for a fuel cell of claim 10, wherein each screen member has a mesh size in a range of 20% to 60% of each unit catalyst.

12. The plate-type reactor for a fuel cell of claim 10, wherein the plate-type reactor main body includes bonding grooves for placing the screen members respectively at the entrance and the exit of the path.

13. The plate-type reactor for a fuel cell of claim 1, wherein the plate-type reactor main body includes a reactant inlet connected to the entrance of the path and a product outlet connected to the exit of the path.

14. The plate-type reactor for a fuel cell of claim 1, wherein the reactant is a fuel containing hydrogen as a main component, and
the plate-type reactor includes a reformer for generating a reforming gas by a reforming reaction of the fuel.

15. A fuel cell system comprising:
an electricity generating element for generating electrical energy through electrochemical reactions;
a plate-type reactor for generating hydrogen gas from a liquid fuel and supplies the hydrogen gas to the electricity generating element;
a fuel supplier for supplying fuel to the plate-type reactor; and
an oxidant supplier for supplying an oxidant to the electricity generating element,
wherein the plate-type reactor comprises;
a plate-type reactor main body having a path for allowing a reactant to flow; and
a catalyst formed in the path to promote a chemical reaction of the reactant,
wherein the catalyst comprises a first catalyst layer coated on a surface of the path and a second catalyst layer filled in a remaining space of the path.

16. A method of increasing the contact area ratio of a catalyst material to a reactant in a fuel cell plate-type reformer, comprising:
forming a channel in the fuel cell plate-type reformer for allowing an input reactant to flow;
layering a first catalyst on a surface of the channel; and
filling remaining space of the channel with a second catalyst.

17. The method of claim 16, wherein the second catalyst includes a plurality of pellet shaped unit catalysts.

18. The method of claim 17, further comprising locating screen members at an extrance and exit of the channel to confine the pellet shaped unit catalysts within a portion of the channel.
